(19) United States
(12) Patent Application Publication
(10) Pub. No.: US 2017/0207044 A1
(43) Pub. Date: Jul. 20, 2017

(54) DISCONNECTOR FOR ELECTRICAL LINES AND SYSTEMS WITH HIGH CURRENT AND HIGH SHORT-CIRCUIT VALUE

(71) Applicant: General Electric Technology GmbH, Baden (CH)

(72) Inventors: Fabio BALDO, Noventa di Piave (IT); Vincenzo GIRLANDO, Noventa di Piave (IT)

(21) Appl. No.: 15/324,780

(22) PCT Filed: Jul. 25, 2014
(86) PCT No.: PCT/IB2014/063409

§ 371 Date: Jan. 9, 2017

(51) Int. Cl. H01H 31/32

(52) U.S. Cl. CPC H01H 31/32

(57) ABSTRACT

A disconnector is provided for electrical lines with high current and high short-circuit value, comprising two mutually spaced fixed structures, each for connection to a respective portion of an electrical line, and a movable connection assembly, which is supported by a first one of the two fixed structures with means for the movement of the movable connection assembly toward the second one of the two fixed connection structures. Each one of the fixed connection structures comprises a tubular jacket, for support and conduction, which supports at one end, annular contact elements arranged for movable coupling with a corresponding moving contact of the movable connection assembly, and at the opposite end, couplings for connection to the corresponding portion of electrical line. The movable connection assembly comprises at least two moving contacts carried within the first fixed connection structure by a supporting frame connected to the movement means.

### BACKGROUND

Embodiments of the present invention relate to a disconnector for electrical lines and systems with high current and high short-circuit value.

In the field of electrical disconnectors, currently the need is felt increasingly of lines with high electric current, approximately 12,000 amperes, but also for example of hydroelectric systems and medium-voltage lines, having a high short-circuit value, approximately 250,000 amperes, to have disconnectors that are simpler and at the same time have a higher performance, therefore with less mass to move for the actuation of the disconnector and therefore capable of lower opening and closing speeds than currently known similar disconnectors.

Disconnectors of the known type, furthermore, have an actuation that entails a stepwise closing and opening motion, which therefore is slow and has a limited precision.

### BRIEF DESCRIPTION

The aim of the present invention is to provide a disconnector the closing and opening movements of which are faster and more fluid than those of disconnectors of the known type with an equal conduction and short-circuit performance.

Within the scope of this aim, an object of the invention is to provide a disconnector that is structurally simple and lighter than similar known disconnectors.

Another object of the invention is to provide a disconnector the structural simplicity of which lowers production costs and which is therefore cheaper than similar disconnectors of the known type.

This aim, as well as these and other objects that will become more apparent hereinafter, are achieved by a disconnector for electrical lines with high current and high short-circuit value, of the type comprising two mutually spaced fixed structures, each for connection to a respective portion of an electrical line, and a movable connection assembly, which is supported by a first one of the two fixed structures with means for the movement of the movable connection assembly toward the second one of the two fixed connection structures. Each one of the two fixed connection structures comprises a tubular jacket, for support and conduction, which supports, at one end, annular contact elements arranged for movable coupling with a corresponding moving contact of the movable connection assembly, and at the opposite end, couplings for connection to the corresponding portion of electrical line.

The movable connection assembly comprises at least two moving contacts carried within the first fixed connection structure by a supporting frame connected to the movement means, and the movement means are configured for the translation of the moving contacts until coupling occurs with the corresponding annular connection elements of the second fixed connection structure. Additionally, the moving contacts are coupled stably to the annular connection elements of the first fixed structure that contains them and supports them.

### BRIEF DESCRIPTION OF THE DRAWINGS

Further characteristics and advantages of the invention will become more apparent from the description of a preferred but not exclusive embodiment of the disconnector for electrical lines with high current and high short-circuit value according to an embodiment of the invention, illustrated by way of non-limiting example in the accompanying drawings, wherein:

FIG. 1 is a perspective view of the disconnector according to an embodiment of the invention;

FIG. 2 is a perspective view of the first fixed structure of the disconnector according to an embodiment of the invention;

FIG. 3 is a top sectional view of the disconnector according to an embodiment of the invention in the open circuit configuration;

FIG. 4 is a portion of a sectional top view of the disconnector according to an embodiment of the invention in the closed circuit configuration;

FIG. 5 is another perspective view of the disconnector according to an embodiment of the invention; and

FIGS. 6 and 7 are views of a detail of the disconnector according to an embodiment of the invention.

### DETAILED DESCRIPTION

With reference to the cited figures, a disconnector for electrical lines with high current and high short-circuit value is designated generally by the numeral 10.

The disconnector 10 comprises two mutually spaced fixed structures 11 and 12, each for connection to a respective portion of an electrical line, and a movable connection assembly 13, which is supported by a first one 11 of the two fixed structures 11 and 12 with means 14 for the movement of the movable connection assembly 13 toward the second one 12 of the two fixed connection structures 11 and 12.

The particularity of embodiments of the invention resides in the fact that each one of the two fixed connection structures 11 and 12 comprises a tubular jacket 15 and 16 respectively, for support and conduction, made for example of aluminum, which supports, at one end, annular contact elements, respectively 17 and 18, which are positioned for movable coupling to a corresponding moving contact 19, 20, 21 and 22 of the movable connection assembly 13, and at the opposite end, couplings 23 and 24 respectively for connection to the corresponding portion of the electrical line.

The movable connection assembly 13 comprises four moving contacts 19, 20, 21 and 22, which are supported within the first fixed connection structure 11 by a supporting frame 25 connected to the movement means 14.

These movement means 14, described in more detail hereinafter, are configured for the translation of the moving contacts 19 and 20 until coupling occurs with the corresponding annular connection elements 18 of the second fixed connection structure 12.

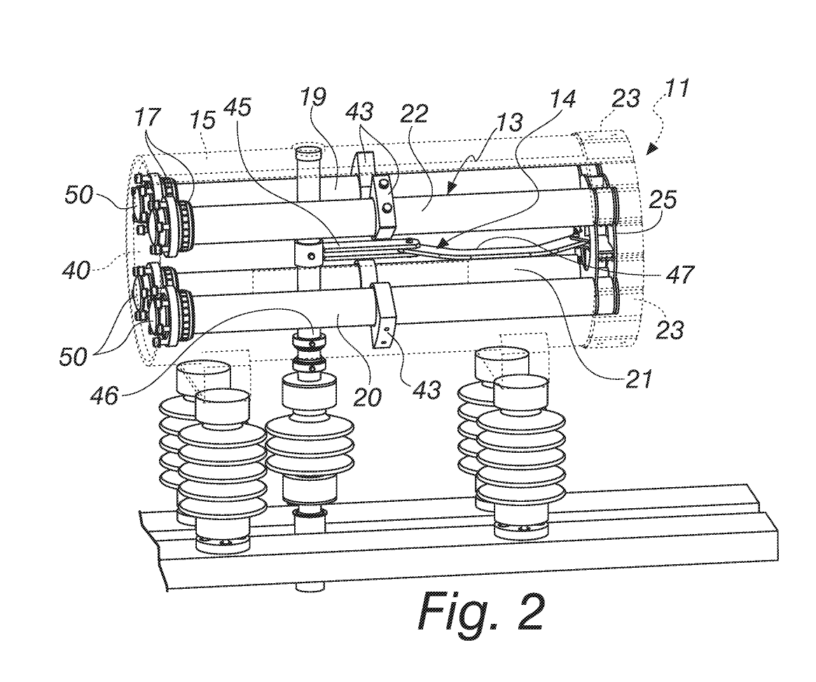

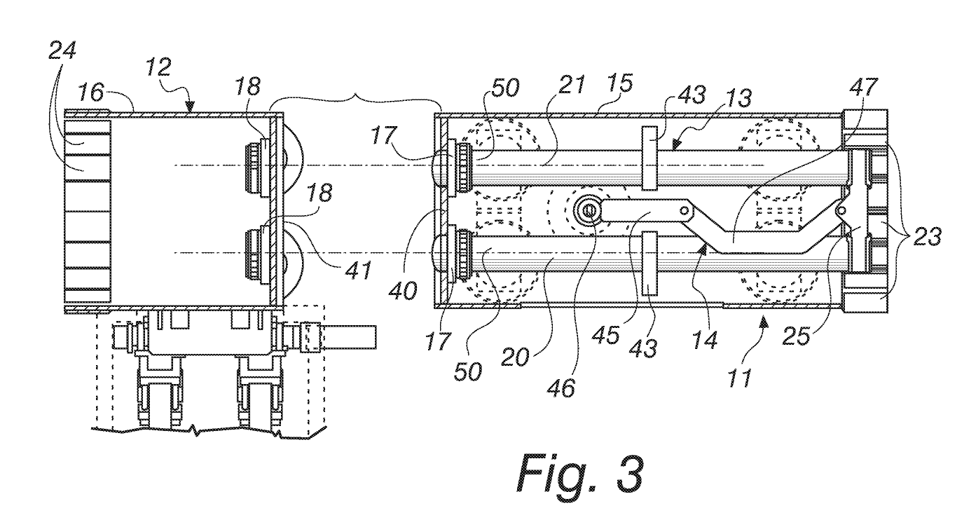

The moving contacts 19, 20, 21 and 22 are coupled stably to the annular connection elements 17 of the first fixed structure 11, which contains them and supports them, as is clearly visible in FIGS. 2 to 4.

Each one of the tubular jackets 15 and 16 is cylindrical and is supported by corresponding electrical insulation posts 26 and 27 respectively.

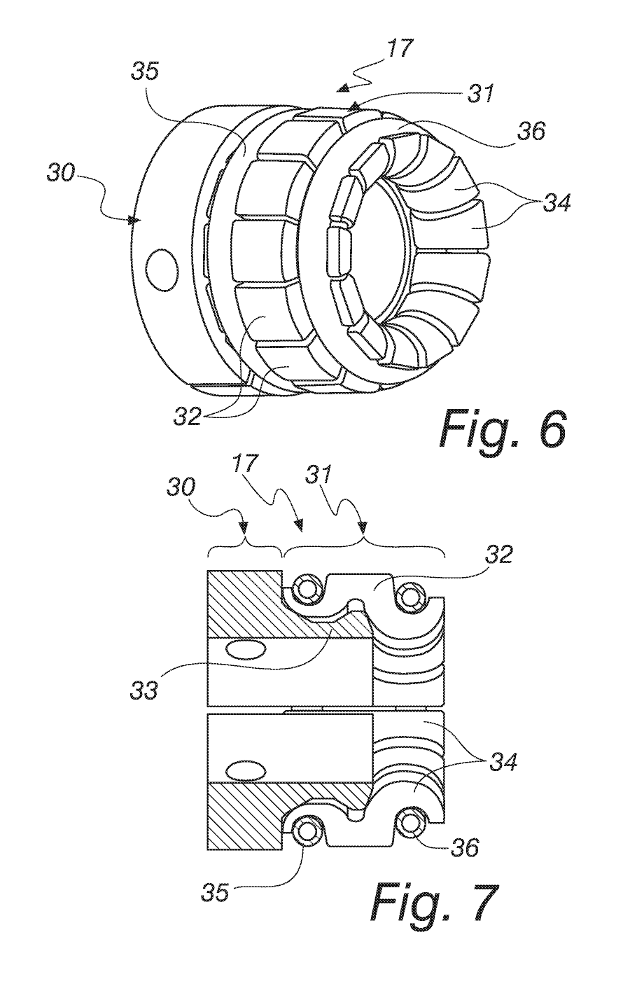

The annular contact elements 17 and 18 are of the “tulip” type, one of which, designated by the reference numeral 17, is shown clearly in FIGS. 6 and 7.

A similar annular contact element, for example 17, comprises a rigid part 30 and a part 31 that can be widened and is preset to widen in a radial direction upon the passage of the corresponding moving contact 19, 20, 21, or 22.

The part 31 that can be widened has a series of laterally adjacent contact bodies 32, which are contoured to arrange themselves side by side so as to surround perimetrically an engagement collar 33 of the rigid part 30 with a contact portion 34 that protrudes beyond the engagement collar 33.

The contact bodies 32 are retained on the collar 33 by a first elastic ring 35.

The contact portions 34 are pushed in a radial direction toward the axis of the annular element 17 by a second elastic ring 36.

The action of the second elastic ring 36 produces stable contact between the annular element 17 and of course 18 and the moving contact 19, 20, 21 or 22 that passes through it.

The annular elements 17 of the first fixed structure 11 are supported by a circular conduction plate 40, which closes the tubular jacket 15 on the side of the second fixed structure 12.

The annular elements 18 of the second fixed structure 12 are supported by a circular conduction plate 41, which closes the tubular jacket 16 on the side of the first fixed structure 11.

Each one of the connection couplings 23 and 24 is constituted by a metallic plate that is fixed to the circular edge of the respective tubular jacket 15 and 16 with an arrangement that is substantially tangent to the outer surface of the tubular jacket.

The moving contacts 19, 20, 21 and 22 are four in number, each of which is formed by a metallic tube, made for example of copper.

These four moving contacts 19, 20, 21 and 22 are arranged symmetrically at 90° of angular distance with respect to each other relative to the axis of the tubular jacket 15.

The presence of four contacts allows division of the current so that one quarter of the current passes through each one of the moving contacts; the symmetrical arrangement allows the current to divide itself equally among the moving contacts, and thus the electrodynamic forces that are generated are balanced.

The four moving contacts 19, 20, 21 and 22 are supported by the supporting frame 25, which is clearly visible in FIGS. 2, 3 and 4.

The supporting frame 25 is constituted by a disk-like body with four recesses, in each of which one end of a moving contact 19, 20, 21 and 22 is fixed.

The moving contacts 19, 20, 21 and 22 are guided within the tubular jacket 15 by corresponding annular brackets 43 that are fixed inside the same tubular jacket 15 and are each stably inserted in a corresponding annular connection element HT as shown in FIGS. 2, 3 and 4.

The movement means 14 comprise a rod and crank mechanism, with a first bar 45 that forms the crank element and is actuated by a rotating shaft 46 that is arranged with a vertical axis and in turn is actuated by an electric motor, not shown for the sake of simplicity, and a second bar 47 that forms the rod element, which is pivoted at one end to the first bar 45 and at the opposite end to the supporting frame 25.

The operation of the disconnector 10 according to an embodiment of the invention is as follows.

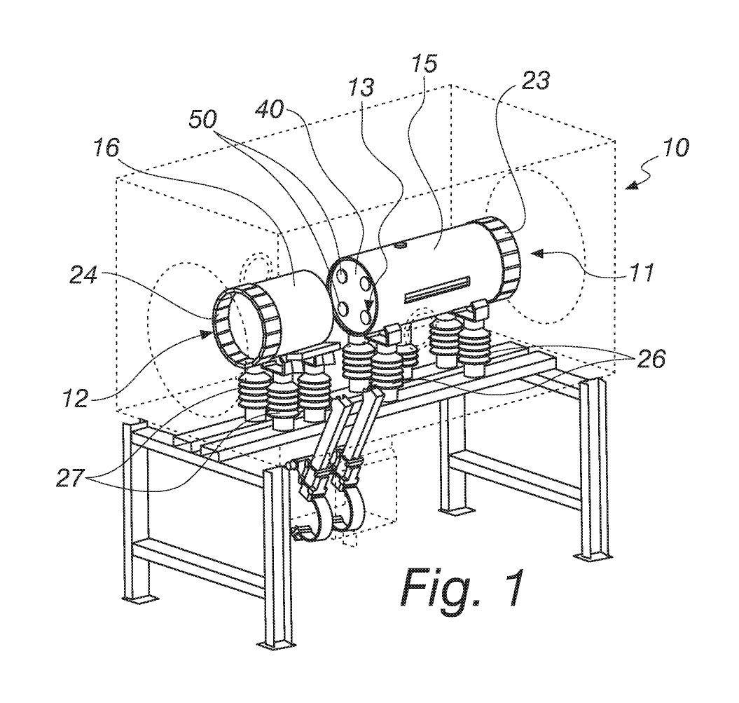

In a first open circuit configuration, as shown in FIGS. 1, 2 and 3, the moving contacts 19, 20, 21 and 22 of the connection assembly 13 are inside the first fixed connection structure 11, with the ends 50 of the moving contacts 19, 20, 21 and 22 coupled to the corresponding annular connection elements 17.

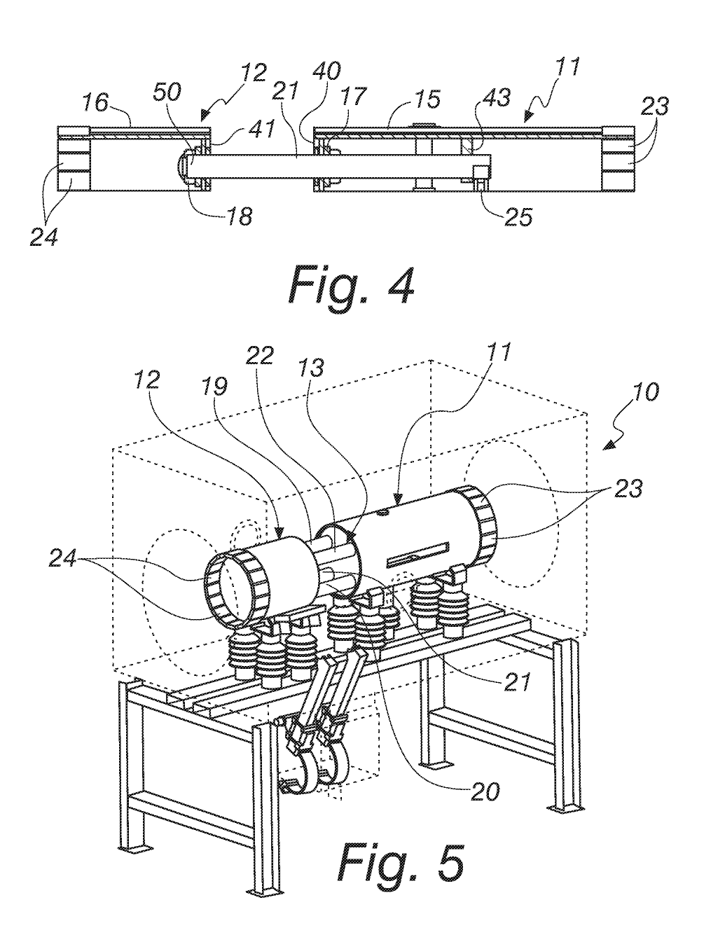

By actuating the movement means 14, the rotating shaft 46, by rotating through 180° by means of the movement of the two bars 45 and 47, causes the translation of the supporting frame 25 and with it of the moving contacts 19, 20, 21 and 22, which translate until they are coupled to the corresponding annular connection elements 18 of the second fixed connection structure 12, so as to close the disconnector, as shown in FIGS. 4 and 5.

The closure of the disconnector by simple translation of the moving contacts renders the closing and opening operations of the disconnector simple and particularly quick to perform with respect to similar disconnectors of the known type.

In practice it has been found that embodiments of the invention achieve the intended aim and objects.

In particular, embodiments of the invention provide a disconnector in which the closing and opening movements are faster and more fluid, i.e., continuous and not stepwise, with respect to disconnectors of the known type with equal-conduction and-short-circuit-performance nd″ which thanks to the splitting of the current over the four moving contacts is well suited for applications for high electric current lines, approximately 12,000 amperes, and having a high short-circuit value, approximately 250,000 amperes.

Moreover, embodiments of the invention provide a disconnector that is structurally simpler and lighter than similar known disconnectors.

Moreover, embodiments of the invention provide a disconnector the structural simplicity of which affects advantageously production costs and is therefore cheaper than similar disconnectors of the known type.

Embodiments of the invention thus conceived are susceptible of numerous modifications and variations, all of which are within the scope of the inventive concept; all the details may furthermore be replaced with other technically equivalent elements.

In practice, the components and materials used, so long as they are compatible with the specific use, as well as the contingent shapes and dimensions, may be any according to the requirements and the state of the art.

What is claimed is:

1. A disconnector for electrical lines with high current and high short-circuit value, comprising:
two mutually spaced fixed structures, each configured for connection to a respective portion of an electrical line;
a movable connection assembly, which is supported by a first one of said two fixed structures, with movement means configured to move the connection assembly toward the second one of said two fixed structures,
wherein each one of said two fixed connection structures comprises:
a tubular jacket, for support and conduction, configured to support, at one end, annular contact elements arranged for movable coupling with a corresponding moving contact of said movable connection assembly, and at the opposite end, couplings for connection to the corresponding portion of electrical line;
said movable connection assembly comprising at least two moving contacts carried within said first fixed connection structure by a supporting frame connected to said movement means, said movement means being configured for the translation of said moving contacts until coupling occurs with the corresponding annular connection elements of the second fixed connection structure, said moving contacts being coupled stably to the annular connection elements of said first fixed structure that contains them and supports them.

2. The disconnector according to claim 1, wherein each one of the tubular jackets is cylindrical and is supported by corresponding electrical insulation posts.

3. The disconnector according to claim 1, wherein said annular contact elements are of the “tulip” type.

4. The disconnector according to claim 1, wherein said annular elements of the first fixed structure are supported by a circular conduction plate which closes the tubular jacket on the side of the second fixed structure, said annular elements of the second fixed structure being supported by a circular conduction plate, which closes the tubular jacket on the side of the first fixed structure.

5. The disconnector according to claim 1, wherein said connection couplings are each constituted by a metallic plate that is fixed to the circular edge of the respective tubular jacket, with an arrangement that is substantially tangent to the outer surface of said tubular jacket.

6. The disconnector according to claim 1, wherein there are four moving contacts, each formed by a metallic tube.

7. The disconnector according to claim 1, wherein said four moving contacts are arranged symmetrically at 90° of angular distance from each other with respect to the axis of the tubular jacket.

8. The disconnector according to claim 1, wherein said supporting frame is constituted by a disc-like body with four recesses, in each of which an end of a moving contact is fixed.

9. The disconnector according to claim 1, wherein said moving contacts are guided within the tubular jacket by corresponding annular brackets that are fixed inside said tubular jacket and are each stably inserted in a corresponding annular connection element.

10. The disconnector according to claim 1, wherein said movement means comprise a rod and crank mechanism, with a first bar that forms the crank element that is actuated by a rotating shaft, which is arranged with a vertical axis, which in turn is actuated by an electric motor, and a second bar that forms the rod element and is pivoted at one end to the first bar and at the opposite end to the supporting frame.

11. The disconnector according to claim 6, wherein the four moving contacts are formed by a metallic tube made of copper.
